(19) United States
(12) Patent Application Publication
(10) Pub. No.: US 2006/0279412 A1
(43) Pub. Date: Dec. 14, 2006

(54) System for using RFID tags as data storage devices

(76) Inventors: Joshua Harold Holland, Cedar Rapids, IA (US); James Edward Seely, Linn, IA (US); Hunter Martin Leland, Cedar Rapids, IA (US)

Correspondence Address: BRIAN M BERLINER, ESQ;O'MELVENY & MYERS, LLP, 400 SOUTH HOPE STREET, LOS ANGELES, CA, 90071-2899, US

(21) Appl. No.: 11/151,855

(22) Filed: Jun. 13, 2005

(51) Int. Cl. H04Q 5/22; H04J 3/24

(52) U.S. Cl. 340/10.51; 370/473

(57) ABSTRACT

The invention provides systems and methods for using radio frequency (RF) transponders interrogators for storing and retrieving data files. In one embodiment, the RF interrogator comprises a microcontroller module that retrieves a data file from a buffer memory space and breaks up the data file into multiple data packets, each data packet comprising a data file identifier and a sequence number. The present invention also provides a data storage device that comprises an RF transponder and a microcontroller that is in communication with the transponder via the external memory interface. In one embodiment, the transponder receives data over an RF broadcast, assigns an address to the data, and sends the data to the microcontroller via the external memory interface for storage at the assigned address.

### BACKGROUND OF THE INVENTION

1. Field of the Invention

The present invention relates to radio frequency (RF) transponders and, more particularly, to a system and method for storing digital information onto one or more RF transponders.

2. Description of Related Art

Radio frequency (RF) transponders are used in many applications. In the automatic data identification industry, the use of RFID transponders (also known as RFID tags) has grown in prominence as a way to obtain data regarding an object onto which an RFID tag is affixed. An RFID tag generally includes memory in which information may be stored. An interrogator containing a transmitter-receiver unit is used to query an RFID tag that may be at a distance from the interrogator and moving relative to the interrogator. The RFID tag detects the interrogating signal and transmits a response signal containing encoded data back to the interrogator. Such RFID tags may have a memory capacity of several kilobytes or more, which is substantially greater than the maximum amount of data that may be contained in a bar code symbol or other types of human-readable indicia. Further, the RFID tag memory may be re-written with new or additional data, which would not be possible with a printed bar code symbol. RFID tags may also be readable at a distance without requiring a direct line-of-sight view by the interrogator, unlike bar code symbols or other types of human-readable indicia that must be within a direct line-of-sight and which may be rendered entirely unreadable if obscured or damaged. The RFID tags may either extract their power from the RF interrogating field provided by the interrogator, or may include their own internal power source (e.g., a battery).

More particularly, an RFID tag includes a semiconductor chip containing RF circuitry, control logic, and memory. The semiconductor chip may be mounted on a substrate that also includes an antenna. In some applications, RFID tags are manufactured by mounting the individual elements to a circuit card made of epoxy-fiberglass composition or ceramic. The antennas are generally sections of wire (e.g., loops) soldered to the circuit card or consist of metal etched or plated onto the circuit card. The whole assembly may be encapsulated, such as by enclosing the circuit card in a plastic box or molded into a three dimensional plastic package. Recently, thin flexible substrates such as polyamide have been used to reduce the size of the RFID tag in order to increase the number and type of applications to which they may be utilized.

The application of RFID tags in the field of automatic data identification typically involves storing a digital representation of the object or product to which an RFID tag is attached. For example, the RFID tag can store the product's UPC code or other information, such as, color, style, etc. While the typical memory capacity of an RFID tag (e.g., on the order of several kilobytes) is sufficient for storing these types of identification data, this level of memory capacity places constraints on the amount and type of data that can be stored on an RFID tag. For example, applications involving the storage and wireless distribution of large files, or the wireless installation/configuration of peripheral devices, will typically require data storage capacities that greatly exceed a few kilobytes.

One approach to using RFID tags for storing large amounts of data is simply to increase the memory capacity of the RFID tags. This approach, however, is generally not practical because the RFID tags with increased memory capacity will typically require an increased amount of power to operate. In addition, this approach would substantially increase the cost of each RFID tag, and consequently would be commercially infeasible in many situations. Accordingly, it is desirable to provide a system for using RFID tags to store device configuration information or other large files.

### SUMMARY OF THE INVENTION

The present invention provides a system for using RF transponders for the storage and transmission of digital information, such as data files. While RF transponders have been used to store digital information that are on the order of a few hundred bytes, they have not heretofore been successfully adapted to store relatively larger amounts of information as described herein.

In accordance with one aspect of the embodiments described herein, there is provided a system for writing digital information (e.g., a large data file) onto one or more RF transponders. In one embodiment, the system comprises a microcontroller module, a digital signal processing module providing direct control over operations of a radio module in response to commands provided by the microcontroller, the radio module providing RF communications with the transponders. The microcontroller module retrieves the digital information from the buffer memory space and breaks up the digital information into multiple data packets, each data packet comprising a data file identifier and a sequence number. The digital signal processing module directs the radio module to broadcast the data packets over a RF modulated signal to the transponders for writing thereon.

In accordance with another aspect of the embodiments described herein, there is provided a method of writing digital information onto multiple RF transponders. In one approach, the method comprises the steps of determining the amount of data in the digital information (e.g., a data file), calculating the number of transponders required to hold the determined amount of data, verifying that there are a sufficient number of transponders to hold the data in the digital information, breaking up the digital information into multiple data packets, and broadcasting the data packets over a RF modulated signal to the transponders for writing thereon. In another approach, the method further comprises the step of encrypting and/or compressing the digital information.

In accordance with another aspect of the embodiments described herein, there is provided an RF data storage device. In one embodiment, the device comprises an RF transponder, the transponder comprising an internal memory and an external memory interface, and a microcontroller that is in communication with the transponder via the external memory interface, the microcontroller comprising a non-volatile memory unit. The RF transponder receives data over an RF broadcast, temporarily stores the data in the internal memory, assigns an address to the data, and sends the data to the microcontroller via the external memory interface for storage in the non-volatile memory unit at the assigned address.

In accordance with another aspect of the embodiments described herein, there is provided a remote data sharing system. In one embodiment, the system comprises a sensor that is in communication with a microcontroller, the microcontroller comprising a non-volatile memory unit and an analog-to-digital converter, and an RF transponder that is in communication with the microcontroller, the transponder comprising an internal memory. The sensor takes a first measurement from a first location and sends the first measurement to the converter, which converts the first measurement into a first digital data value and stores the first digital data value in the memory unit. The RF transponder retrieves the first value from the microcontroller's memory unit and stores the first value in the transponder's internal memory where the first value can be read by an RF interrogator. In another embodiment, the system comprises a second sensor that is in communication with the microcontroller.

A more complete understanding of the data storage and transmission systems described herein will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a block diagram of an embodiment of an RFID tag.

FIG. 2 is a block diagram of an embodiment of a system for storing, transmitting, and retrieving large digital information with a plurality of RFID tags.

FIG. 3 is a block diagram illustrating an RF interrogator and an RFID tag.

FIG. 4 is a first embodiment of a microcontroller module of an RF interrogator.

FIG. 5 is a block diagram illustrating a format for a data packet created and transmitted by an RF interrogator according to one aspect of the embodiments described herein.

FIG. 6 is a flowchart illustrating an exemplary algorithm for writing digital information to one or more RFID tags.

FIG. 7 is a flowchart illustrating an exemplary algorithm for reading digital information to one or more RFID tags.

FIG. 8 is a block diagram of an embodiment of an RFID data storage device.

FIG. 9 is a block diagram of an embodiment of a remote temperature measurement system.

FIG. 10 is a block diagram of an embodiment of an RFID tag that is programmed with a reserved configuration region that allows RFID interrogators to know the type of peripheral to which the RFID tag is attached.

FIG. 11 is a block diagram of another embodiment of an RFID tag that is programmed with a reserved configuration region.

FIG. 12 is a block diagram of an embodiment of a system for interfacing an RFID tag directly with the energy source of an external memory microcontroller.

### DETAILED DESCRIPTION OF THE PREFERRED EMBODIMENT

The present invention satisfies the need for a system and method of using one or more RFID tags for the storage and transmission of configuration information or other digital information (e.g., data files) that are too large to fit on a single RFID tag (e.g., files that are larger than a few hundred bytes). In the detailed description that follows, like element numerals are used to describe like elements illustrated in one or more of the figures.

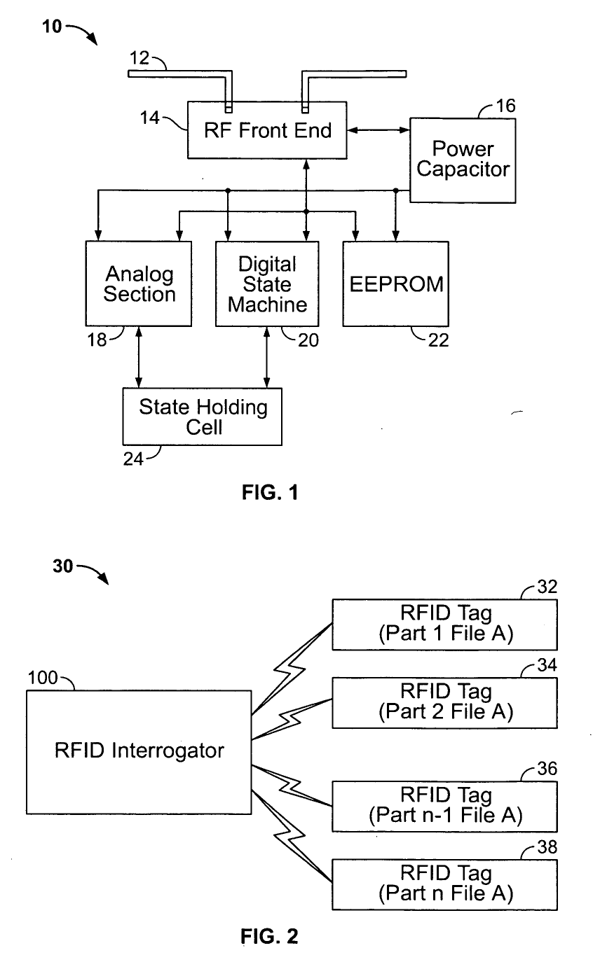

With reference to FIG. 1, there is provided a block diagram of an exemplary RFID tag 10. The exemplary RFID tag 10 includes an RF front end 14, a power capacitor 16, an analog section 18, a digital state machine 20, a memory 22, and a state holding cell 24. The RF front end 14 is coupled to an antenna 12, and may include an RF receiver that recovers analog signals that are transmitted by an RFID interrogator and an RF transmitter that sends data signals back to the RFID interrogator. The RF transmitter may further comprise a modulator adapted to backscatter modulate the impedance match with the antenna 12 in order to transmit data signals by reflecting a continuous wave (CW) signal provided by the RFID interrogator. As shown in FIG. 1, the antenna 12 comprises a dipole, but it should be appreciated that other types of antennas could also be advantageously utilized, such as a folded dipole, a meander dipole, a dipole over ground plane, a patch, and the like. The RF field provided by the RFID interrogator presents a voltage on the antenna 12 that is rectified by the RF front end 14 and used to charge the power capacitor 16. The power capacitor 16 serves as a voltage source for the analog section 18, digital state machine 20, and the memory 22 of the RFID tag 10.

The analog section 18 converts analog data signals recovered by the RF front end 14 into digital signals comprising the received commands, recovers a clock from the received analog signals, and converts digital data retrieved from the memory 22 into analog signals that are backscatter modulated by the RF front end 14. The digital state machine 20 provides logic that controls the functions of the RFID tag 10 in response to commands provided by the RFID interrogator that are embedded in the recovered RF signals. The digital state machine 20 accesses the memory 22 to read and/or write data therefrom. The memory 22 may be provided by an EEPROM or like semiconductor memory device capable of maintaining a stored data state in the absence of an applied voltage. The RF front end 14, analog section 18, digital state machine 20, and memory 22 communicate with each other through respective input/output (I/O) buses, or alternatively, a common I/O bus may carry all such communications. It should be appreciated that the RF front end 14, analog section 18, digital state machine 20, memory 22, and the state holding cell 24 (discussed below) may be provided by separate circuit elements, or may be sub-elements of a single mixed-signal integrated circuit, such as an application specific integrated circuit (ASIC), field programmable gate array (FPGA), and the like. The state holding cell 24 is coupled between the analog section 18 and the digital state machine 20.

As discussed above, analog signals recovered by the analog section 18 include commands provided by the RFID interrogator that are then executed by the digital state machine 20. Certain commands cause the RFID tag 10 to change state. Exemplary states for the RFID tag 10 include: (i) ready state, when the tag is first powered up; (ii) identification state, when the tag is trying to identify itself to the RFID interrogator; and, (iii) data exchange state, when the tag is known to the RFID interrogator and is either reading data from memory or writing data to memory. Other tag states may also be included. The state determines how a given command is executed by the RFID tag 10. For example, an initialization command may be executed by an RFID tag in any of the aforementioned states, while a command to lock a byte of memory will generally be executed contingent upon the RFID tag being advanced to the data exchange state. The state may be defined by a digital value (e.g., one or two bits in length).

In one embodiment, the state holding cell 24 provides a storage location for the state information. As the analog section 18 recovers commands that are passed to the digital state machine 20 for execution, state information is also passed to the state holding cell 24. In the event of a temporary loss of power to the RFID tag 10, the digital state machine 20 can restore the state existing prior to the loss of power by accessing the state information contained within the state holding cell 24.

In accordance with one aspect of the embodiments described herein, there is provided a system for breaking up and writing digital information (e.g., a large data file) onto multiple RFID tags. A file or some other large amount of digital information may be too large to store on a single tag, so the digital information is broken up and spanned across multiple RFID tags. With reference to FIG. 2, there is provided an interrogator 100 for multi-card information storage and retrieval. In the present embodiment, the digital information comprises a data file—specifically, exemplary File A. It will be understood, however, that the digital information is not limited to data files and that the embodiments described herein are only meant to illustrate exemplary embodiments. The interrogator 100 comprises an RFID reader/writer and is in communication with two or more RFID tags (e.g., tags 32, 34, 36, and 38), and also comprises File A that is larger than the memory available on any of the RFID tags. Each of the RFID tags typically dedicates a couple of bytes of memory to specify the order and information about exemplary large File A, while dedicating the rest of the bytes on the RFID tag for storing a portion of File A. File A is preferably a binary file and is preferably in a suitable compressed format.

The interrogation system 100 breaks up File A into n portions or data packets, wherein the size of each portion is limited to the maximum number of bytes that will fit onto each of the RFID tags. The n portions the makeup the File A can be reconstituted on any computer or device that has or is in communication with an RF reader or interrogator, as explained in further detail below. The interrogator 100 interrogates the RFID tags (e.g., tags 32, 34, 36, and 38), collects all n portions of File A, and reconstitutes them back onto the computer 31. In another example, the n portions of File A are transferred to a remote location and then reconstituted onto a device in the remote location.

In another embodiment (not illustrated), the multi-card storage and retrieval system 30 is configured to store and retrieve multiple large files (e.g., Files B and C) from a plurality of RFID tags. Again, the large files B and C are ones that are too large to store on any one of the RFID tags. For example, the system 30 can be configured to transfer all portions of File B from a first set of tags to the reader on the receiving computer before commencing the transfer of the portions of File C from a second set of tags to the reader. Alternatively, the system 30 can be configured to transfer portions of both Files B and C in one or more of the RFID tags. In yet another example, one or more of the RFID tags are configured to store and transfer data portions from only one of Files B or C.

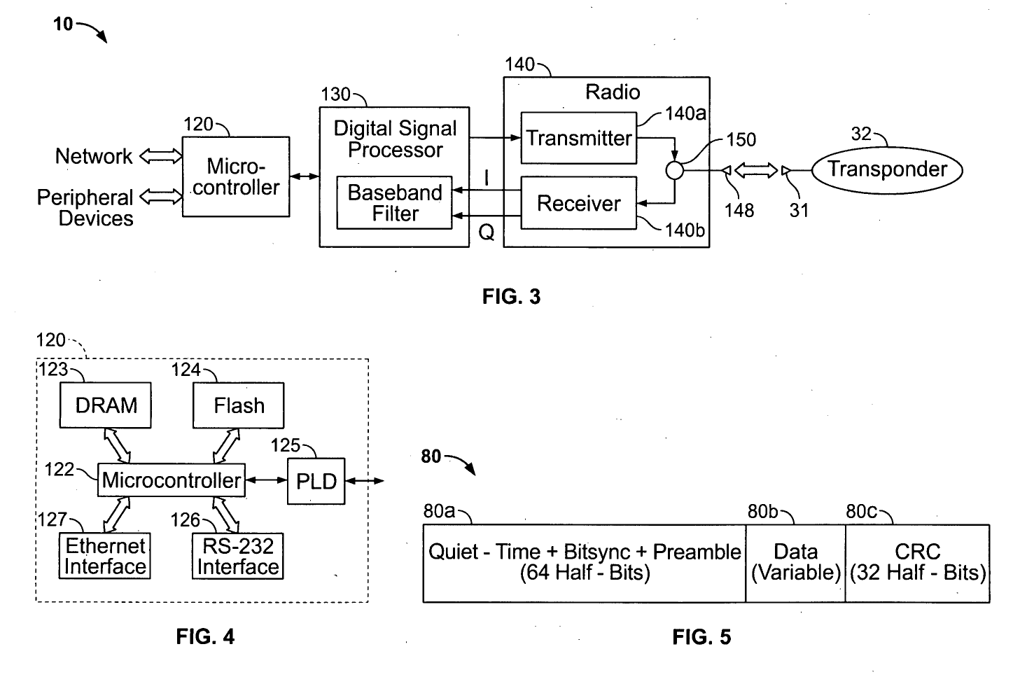

With reference to FIG. 3, there is provided an RFID interrogator 100 and a representative RFID tag 32. It will be understood that the interrogator is typically in communication with multiple RFID tags even though only one tag 32 is shown in FIG. 3. In one embodiment, the interrogator 100 comprises a microcontroller module 120, a digital signal processor (DSP) module 130, and a radio module 140. The microcontroller module 120 provides control over high level operation of the interrogator 100 and communicates with an external network and peripheral devices. The DSP module 130 provides direct control over all operations of the radio module 140 in response to high level commands provided by the microcontroller module 120. The radio module 140 provides for RF communications with tag 32. The tag 32 is disposed in proximity to the interrogator 100, and has an antenna 31 that radiates an RF backscattered signal in response to an RF transmission signal provided by the interrogator 100. As known in the art, the tag 32 may either be passive, whereby it receives its power from the modulated electromagnetic field provided by the interrogator 100, or active, whereby it contains its own internal power source, such as a battery.

The radio module 140 further comprises a transmitter portion 140a, a receiver portion 140b, a hybrid 150, and an antenna 148. The hybrid 150 may further comprise a circulator. The transmitter portion 140a includes a local oscillator that generates an RF carrier frequency. The transmitter portion 140a sends a transmission signal modulated by the RF carrier frequency to the hybrid 150, which in turn passes the signal to the antenna 148. The antenna 148 broadcasts the modulated signal and captures signals radiated by the tag 32. The antenna 148 then passes the captured signals back to the hybrid 150, which forwards the signals to the receiver portion 140b. The receiver portion 140b mixes the captured signals with the RF carrier frequency generated by the local oscillator to directly downconvert the captured signals to a baseband information signal. The baseband information signal comprises two components in quadrature, referred to as the I (in phase with the transmitted carrier) and the Q (quadrature, 90 degrees out of phase with the carrier) signals. The hybrid 150 connects the transmitter 140a and receiver 140b portions to the antenna 148 while isolating them from each other. In particular, the hybrid 150 allows the antenna 148 to send out a strong signal from the transmitter portion 140a while simultaneously receiving a weak backscattered signal reflected from the transponder 32.

With reference to FIG. 4, there is provided one embodiment of a microcontroller module 120 that comprises a microcontroller 122, a dynamic random access memory (DRAM) 123, a flash memory 124, a programmable logic device (PLD) 125, an Ethernet interface 127, and an RS-232 interface 126. The microcontroller 122 may be provided by a general-purpose microprocessor adapted to execute a series of instructions (i.e., software or firmware) at a relatively high clock rate, such as the Motorola 68360 series microcontroller. The PLD 125 provides a high-speed serial data interface between the microcontroller module 120 and the DSP module 130, and serves to control the timing and format of signals passing between the microcontroller module 120 and the DSP module 130. The microcontroller module 120 handles the power-up initialization of the interrogator 100, host communications, RFID protocol, and error recovery.

The DRAM 123 is accessible by the microcontroller 122 through a parallel data connection and provides for volatile memory storage of data values generated during the execution of instructions by the microcontroller. The flash memory 124 is also accessible by the microcontroller 122 through a parallel data connection and provides non-volatile memory storage for the microcontroller 122. The flash memory 124 may contain program instructions utilized upon the initial start-up of the interrogator 100. The start-up program is uploaded from the flash memory 124 to the microcontroller 122, and copied to the DRAM 123 to provide a high speed memory access space for execution of the program. It should be appreciated that other types of commercially available, non-volatile memory may be used instead of flash memory, such as an electrically erasable, programmable, read-only memory (EEPROM), or optical or magnetic disk storage devices.

The Ethernet interface 127 and RS-232 interface 126 provide for communications by the interrogator 100 with external systems. As known in the art, the Ethernet interface 127 permits parallel data communication between the interrogator 100 and a wired or wireless local area network (LAN). The RS-232 interface 126 permits serial data communication between the interrogator 100 and peripheral devices, such as a printer, monitor, bar code scanner, or other such device.

Referring now to FIG. 5, there is provided an exemplary data packet 80 communicated by an interrogator 100 to one or more RFID tags (e.g., tags 32, 34, etc.). The data packet 80 is divided into three sections, including an initial synchronization portion 80a, a data portion 80b, and an error correction portion 80c. The initial synchronization portion 80a includes a “quiet-time” pattern, a bit-synchronization pattern, and a preamble. The quiet-time pattern comprises a sequence of half-bits that correspond in duration to the transient settling time of the baseband filter 137. In the present embodiment of the interrogator 100, a quiet-time pattern of thirty-six successive half-bits of “1” is utilized. This relatively short quiet-time pattern is possible by providing transient suppression of the incoming I and Q signals, though it should be appreciated that longer quiet-time patterns may also be utilized. The bit-synchronization pattern comprises a repeating sequence of “10” totaling sixteen half-bits in length. An example of the combined fifty-two half-bit long quiet-time and bit-synchronization patterns is given below as:

1111 1111 1111 1111 1111 1111 1111 1111 1111 1010 1010 1010 1010

The preamble comprises a sequence of half-bits that permits the RFID tag 32 to synchronize with the incoming I and Q signals. The tag 32 uses the preamble to correlate to the decoded half-bits of the received signals. The particular bit sequence of the preamble is specifically chosen to provide optimum auto-correlation characteristics. In a preferred embodiment, the preamble includes at least one Manchester error, and, since a “0” corresponds to a short-circuit condition of the RF/ID tag antenna, the preamble does not include more than two consecutive “0”s. An example of a twelve half-bit preamble pattern is given below as:

1100 0100 1110

The data portion 100b of a data packet contains the information to be communicated from the interrogator 100 to each of the tags (e.g., tags 32, 34, etc.). In a preferred embodiment, the length of the data portion 100b is variable, but it should also be appreciated that fixed length data packets may also be advantageously utilized. As discussed above, the data may be encoded using known encoding schemes, such as Manchester coding and FM0 coding in which two successive half-bits correspond to a single data bit.

The error correction portion 100c following the data portion 100b includes a cyclic redundancy check (CRC) code that enables error correction of the decoded data. In the preferred embodiment of the invention, a sixteen bit (i.e., thirty-two half-bits) CRC code is the one's complement of the remainder generated by the modulo two division of the data packet by the polynomial X¹⁶+X¹²+X⁵+1. The CRC calculation is performed after decoding of the digital bits, as described above.

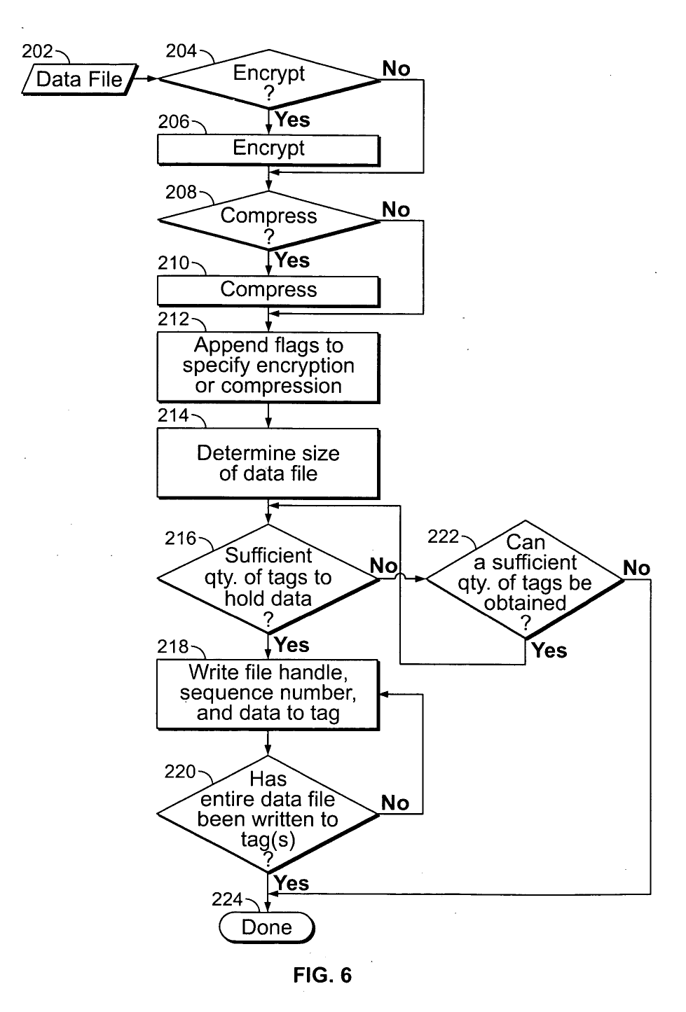

In accordance with one aspect of the embodiments described herein, there is provided a method for breaking up and writing digital information to multiple RFID tags. FIG. 6 illustrates an exemplary algorithm for writing a large data file to RFID tags. The algorithm begins at step 202, where the microcontroller 122 retrieves the data file from memory, preferably via a buffer memory space. At step 204, a determination is made as to whether to encrypt the file. If the file does not need to be encrypted, the algorithm proceeds directly to step 208; otherwise, the microcontroller module 120 encrypts the file at step 206 according to any known suitable encryption algorithm.

At step 208, a determination is made as to whether to compress the file. If the file is to be compressed, the microcontroller module 120 compresses the file at step 210 according to any known suitable compression methodology; otherwise, the algorithm proceeds directly to step 212. At step 212, if the file is encrypted and/or compressed, a flag is appended to the file so that the file can be correctly decrypted and/or decompressed when read back.

The interrogator 100 determines the total size of the file at step 214. At step 216, the interrogator 100 calculates the quantity of tags required to hold all of the data of the file (including the file handle, sequence number, etc.), and determines whether there is a sufficient quantity of tags to hold the data. If there are an insufficient number of tags, the interrogator 100 determines whether a sufficient quantity of tags can be obtained (step 222). If a sufficient quantity of tags exists, the algorithm returns to step 216; otherwise, the algorithm terminates at step 224.

Once the interrogator 100 determines that there are a sufficient number of tags to hold the data, it proceeds to step 218 and breaks up the data file into multiple data packets, explained above and illustrated in FIG. 5. Each packet contains a unique identifier for the data packet sent to a tag, as well as a sequence number so that the data packets on the tags can be later be read back efficiently, even if the data packets are not read in the order they are written to the tags. The interrogator 100 writes the data packets to the tags, incrementing the sequence number until the entire data file, broken up into two or more data packets, has been written to the tags. In one embodiment, the interrogator 100 writes a byte to the tag to indicate that the tag contains a data packet that is part of a larger spanned data file.

At step 220, the interrogator 100 determines whether the entire data file has been written to the tags. If so, the algorithm terminates at step 224; otherwise, the interrogator 100 returns to step 218 and continues to write data packets to the tags until the entire data file has been written to the tags.

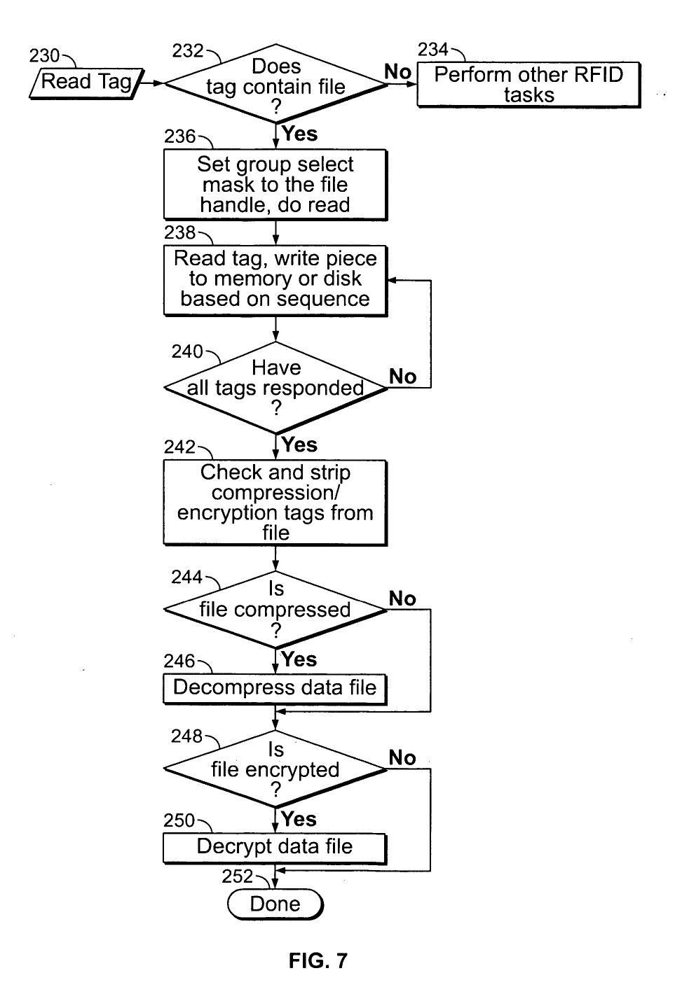

FIG. 7 illustrates an exemplary algorithm for recovering data from multiple RFID tags. The DSP module 130 of the interrogator 100 initiates buffering of the data packet samples by executing a radio receiver interrupt routine, as described in further detail in U.S. Pat. No. 6,501,807, titled “Data Recovery System for Radio Frequency Identification Interrogator,” issued Dec. 31, 2002, the content of which is incorporated herein in its entirety by reference. Starting at step 230, the DSP module 130 retrieves the first sample from a buffer memory space, and then determines whether the sample comprises a data packet of the desired data file at step 232. If so, the interrogator 100 sets its group select mask to the file ID or handle in the tag at step 236; otherwise, the interrogator 100 proceeds to step 234 to perform other RFID related functions. As data packets with the appropriate file ID/handle are read in by the interrogator 100, they are placed into memory or a storage device of the interrogator 100.

At step 238, the radio module 140 transmits an interrogating RF signal to identify and read in data from all RFID tags having the file ID/handle from step 236. At step 240, a determination is made as to whether all tags with the file ID/handle (i.e., a complete set of data packets of the desired data file) have been read. If not, the algorithm loops back to step 238 until all tags having portions of the data file are identified and read in by the interrogator 100. At step 242, the file is checked to determine whether or not it is in a compressed and/or encrypted format. The file is then decompressed and/or decrypted as needed in steps 244, 246, 248, and 250. By step 252, the original data file has been recovered from the tags, at which point the algorithm terminates.

It will be noted that there are numerous practical applications for the system 30 illustrated in FIG. 2. For example, in the context of automobile dealerships, a dealer can have a bank of RFID tags located inside each car, wherein one or more of the tags hold an electronic copy of the pricing sticker or portions thereof. The customer has the option of scanning each sticker into her RFID reader (e.g., located inside a personal digital assistant, cell phone, or the like), and taking electronic copies of the stickers with her. In one application, the customer has the option taking her RFID reading device to an outdoor kiosk with a wireless printer inside to obtain a hardcopy of the stickers from the vehicle she scanned.

In another application, music stores can store clips or samples of their products (e.g., CDs, DVDs, etc.) in attached RFID tags, thereby giving the consumer the option of scanning and listening to the clips before purchasing the products. In yet another application, RFID tags can be placed in vending machines to keep track of certain information, such as, current contents, supply, amount of money inside the machine, whether maintenance is required, etc., thereby enabling a route driver to retrieve such information from a vending machine remotely (e.g., from inside his/her truck).

In one application, computer and electronics device drivers and/or configuration settings are stored in one or more RFID tags attached to the device(s). For example, in the context of computer peripherals (e.g., printers, monitors, etc.), a particular type of driver and/or configuration settings must be loaded onto the computer to enable interaction between the computer and the peripheral. In one approach, the driver and/or configuration settings are stored in RFID tags attached to or inside of the peripherals, and then read by an RF reader/writer attached on the computer, thereby eliminating the need for loading information from installation disk(s) or even plugging the peripherals into the computer in order to enable the peripheral. In one approach, the RFID tags have another bit of information to indicate which tags have software for a particular operating system, thereby enabling installation of the proper software onto a device that queries the RFID tags.

In one embodiment, the system comprises a device having one or more of the RFID tags that contain configuration information needed to setup the proper interaction with other devices. For example, an RFID tag can be attached to a peripheral, such as, for example, a printer (via Bluetooth, serial, network, or the like), wherein the RFID tag contains the necessary information to associate, connect, and print to the printer. As such, a user can use his/her device with a peripheral by scanning the RFID tag with little or no other configuration steps required.

This type of networking approach can be carried over to any number of devices, thereby enabling the out-of-box configuration of systems that comprise a first device (e.g., a computer peripheral) having RFID tags, and a second device (e.g., a personal computer with an RF reader) having RFID interrogating ability. In one embodiment, the first device is part of a mass rollout and configuration of settings for networks, printers and other peripherals. In another embodiment, the first device is a replacement unit that has RFID tags to enable appropriate configuration and communication with other devices straight out of the box.

In accordance with one aspect of the embodiments described herein, there is provided a system and method for interfacing an RFID tag with an external memory module, thereby making it possible to store and transfer one or more large data files from a single RFID tag to an RF reader. As explained previously, many RFID tags do not have more than a few kilobytes of memory (sometimes not more than about 128 bytes of memory). Consequently, RF communication systems that utilize a single RFID tag are often limited in the amount of data than can be stored to and transmitted from the RFID tag to the RF reader.

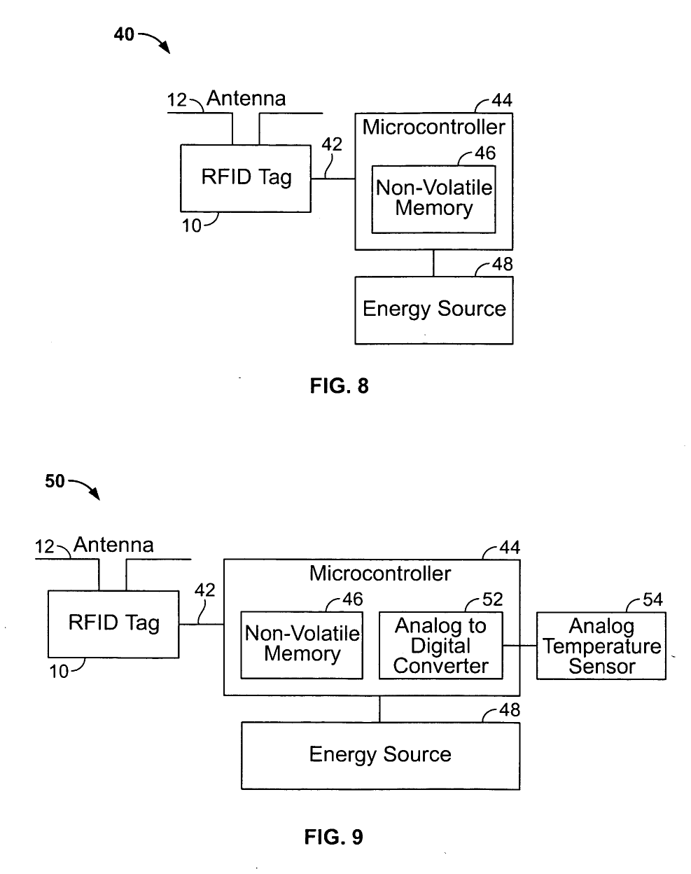

FIG. 8 illustrates an embodiment of an RF data storage device 40 that comprises an RFID tag 10 that interfaces with a microcontroller 44, which typically comprises a non-volatile memory 46, such as, flash memory or the like. The tag 10 functions as an RF communications device, while the microcontroller 44 in effect functions as the external memory module. The communications interface 42 between the tag 10 and the microcontroller 44 typically comprises an address register and a data register for the transfer of data to and from the memory 46. The read/write requests to the external memory interface registers produce serial communication 42 between the tag 10 and the microcontroller 44.

The RFID tag 10 and microcontroller 44 together form a tag-microcontroller assembly. There is almost no limit to the amount of flash memory 46 that can be placed on the tag-microcontroller assembly. Regions of the memory 46 can be mapped to read/write regions in the tag 10 in 100 byte increments or other suitably sized increments or portions, thereby creating a wireless version of the popular USB flash drives. The amount of memory stored on a tag can be increased according to a specific use without altering the RFID tag design, thereby allowing RFID tags to be customized to the specific requirements of the application without changing the tag design, which is often very costly. The non-volatile memory region 46 external to the tag 10 can be mapped into the memory region 22 of the tag 10, thereby facilitating customization of the external memory size and control while minimizing customization of the tag 10, which in turn results in a lower cost system design.

The microcontroller 44 is connected to and powered by an energy source 48, which typically comprises a battery or the like. In one embodiment, the RFID tag 10 is a passive device that is RF powered by an interrogating signal, while the microcontroller 44 is powered by a separate energy source 48 that comprises a battery. In another embodiment, the energy source 48 provides power to the microcontroller 44 and also serves as a supplemental power source to the tag 10 in case there are fluctuations in the level of power delivered to the tag 10 due to variations in the RF environment. In yet another embodiment, the microcontroller 44 is powered by both the energy source 48 and RF signals rectified by the tag 10.

In accordance with one aspect of the embodiments described herein, there is provided a remote data sharing system that collects data, stores the data into memory, and shares the data via RF signals. For example, the data sharing system can function as a remote sensor or a remote general purpose I/O controller. As microcontrollers become more fully featured, peripherals can be memory mapped into the controllable memory of the tag, including but not limited to I/O, analog-to-digital converters, digital-to-analog converters, or the like. For example, with reference to FIG. 9, there is provided a data sharing system 50 that functions as a remote temperature measurement system.

The temperature measurement system 50 shown in FIG. 9 comprises an analog temperature sensor 54 that is connected to a microcontroller 44 via an analog-to-digital converter (ADC) 52. The system 50 comprises an RFID tag 10 with antenna 12, a microcontroller 44 that communicates with tag 10 through a communications interface 42, and an energy source 48 that is connected to the microcontroller 44. The microcontroller 44 comprises a non-volatile memory 46, such as, for example, flash memory or the like. An RF interrogator can read the RFID tag 10 connected to the microcontroller 44 in order to obtain a voltage value that represents the measured temperature. In one embodiment (not illustrated), the RF system 50 comprises multiple RFID tags 10 attached to the surface of an object, which makes it possible to measure temperature gradients of the object's surface.

Typical operation of the temperature measurement system 50 is as follows: First, the sensor 50 takes one or more temperature measurements from a given object or location. The sensor 50 transmits the measurement data to the ADC 52 of the microcontroller 44 which digitizes the temperature data. The data is then stored in the microcontroller's memory 46. The data is then transferred to the RFID tag 10, which in turn shares the temperature data with one or more RF interrogators. The manner in which the data is transferred from the microcontroller 44 to the tag 10 depends in part on the size of the data relative to the amount of memory available on the tag 10. If the size of the data file is greater than the memory on the tag 10, the data file is broken up into multiple data packets that fit on the tag 10, and the data packets are RF transmitted from the tag 10 according to any suitable serial data transmission algorithm.

In accordance with one aspect of the embodiments described herein, there is provided an RFID tag that is programmed with a reserved configuration region that allows RFID readers to know the type of peripheral to which the tag is attached, and thus the memory map needed to access data from the tag and/or external memory devices associated with the tag. This is similar to the function of tuple information provided on a PCMCIA card. For certain applications, the tags require memory storage only insomuch as they identify the configuration information for external devices to which they are attached, thereby shifting the RFID air protocol to be more of a wireless bus than simply a limited data storage device.

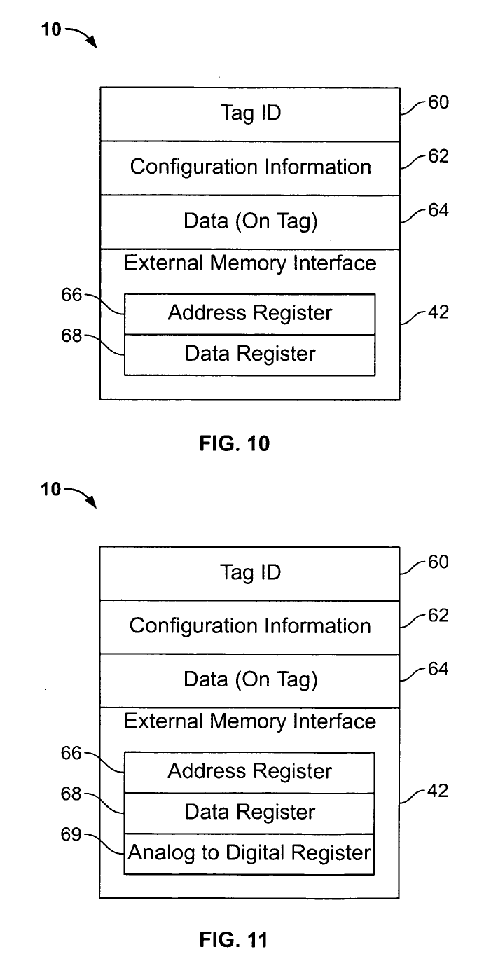

With reference to the block diagram in FIG. 10, in one embodiment, the RFID tag 10 comprises four functional regions—namely, a tag ID region 60, a configuration information region 62, tag data region 64, and an external memory interface region 42. The tag data region 64 typically comprises a memory, such as EEPROM or similar semiconductor memory device that is preferably capable of maintaining a stored data state in the absence of an applied voltage. The external memory interface region 42 typically comprises an address register 66 and a data register 68 to facilitate the transfer of data to or from an external memory device, such as flash memory or a similar non-volatile memory. In another embodiment, shown in FIG. 11, region 42 comprises an address register 66, a data register 68, and an analog-to-digital register 69.

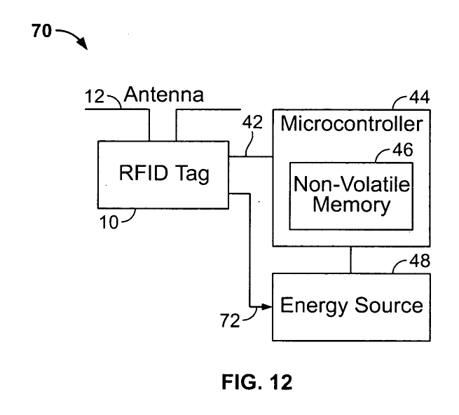

In accordance with one aspect of the embodiments described herein, there is provided a system for interfacing an RFID tag directly with the energy source of an external memory microcontroller to prevent the energy source from unnecessarily depleting. In one embodiment, illustrated in FIG. 12, illustrates an RF communication system 70 that comprises an RFID tag 10 with antenna 12, a microcontroller 44 that communicates with tag 10 through a communications interface 42, a non-volatile memory 46 inside of the microcontroller 44, and an energy source 48 that is in communication with both the microcontroller 44 and the tag 10.

With continued reference to FIG. 12, since the tag 10 derives power from the external RF interrogating field, the microcontroller 44 only needs to be powered when the tag 10 processes an external memory or I/O access. In one embodiment, a wakeup signal 72 from tag 10 to energy source 48 wakes up or activates the microcontroller 44 that is in a low-power or dormant mode. In a preferred embodiment, the microcontroller 44 draws on the energy source 48 only when the tag 10 processes an external memory or I/O access and/or when the tag 10 is unable to derive power from the external RF.

In another embodiment, the tag 10 transmits a hardware or wakeup signal to the microcontroller 44 via communications interface 42 along with the wakeup signal 72 to the energy source 48. In yet another embodiment, the tag 10 transmits a hardware or wakeup signal to the microcontroller 44 via communications interface 42 in lieu of the wakeup signal 72 to the energy source 48.

Having thus described a preferred embodiment of a system for storing and transmitting data files that exceed the memory capacity of a single RF transponder, it should be apparent to those skilled in the art that certain advantages of the within system have been achieved. It should also be appreciated that various modifications, adaptations, and alternative embodiments thereof may be made within the scope and spirit of the present invention. For example, data storage systems with non-volatile memory devices has been illustrated, but it should be apparent that the inventive concepts described above would be equally applicable to systems having other types of memory devices. The invention is solely defined by the following claims.

What is claimed is:

1. A radio frequency (RF) interrogation system for writing digital information onto one or more RF transponders, comprising:
a microcontroller module, the microcontroller module comprising a microcontroller and a buffer memory space; and
a digital signal processing module providing direct control over operations of a radio module in response to commands provided by the microcontroller, the radio module providing RF communications with the transponders;
wherein the microcontroller module retrieves the digital information from the buffer memory space and breaks up the digital information into multiple data packets;
wherein the digital signal processing module directs the radio module to broadcast the data packets over a RF modulated signal to the transponders for writing thereon.

2. The system of claim 1, wherein the microcontroller module comprises DRAM that is accessible by the microcontroller and provides for volatile storage of data values generated during the execution of instructions by the microcontroller.

3. The system of claim 1, wherein the microcontroller module comprises flash memory that provides non-volatile memory storage for the microcontroller.

4. The system of claim 3, wherein the flash memory comprises EEPROM.

5. The system of claim 1, wherein the microcontroller module comprises an Ethernet interface for communicating with an a local area network.

6. The system of claim 1, wherein the microcontroller module comprises an RS-232 interface for communicating with one or more peripheral devices.

7. The system of claim 1, wherein the radio module comprises a local oscillator that generates an RF carrier frequency.

8. The system of claim 1, wherein the microcontroller module encrypts the digital information after retrieving the digital information from the buffer memory space.

9. The system of claim 1, wherein the microcontroller module compresses the digital information after retrieving the digital information from the buffer memory space.

10. The method of claim 1, wherein the digital information comprises a data file.

11. The method of claim 1, wherein at least one data packet comprises a digital information identifier.

12. The method of claim 1, wherein each data packet comprises a sequence number.

13. A method of writing digital information onto multiple radio frequency (RF) transponders, comprising the steps of:
determining the amount of data in the digital information;
calculating the number of transponders required to hold the determined amount of data;
verifying that there are a sufficient number of transponders to hold the data in the data file;
breaking up the digital information into multiple data packets; and
broadcasting the data packets over a RF modulated signal to the transponders for writing thereon.

14. The method of claim 13, further comprising the step of encrypting the digital information.

15. The method of claim 13, further comprising the step of compressing the digital information.

16. The method of claim 13, wherein the step of breaking up the digital information comprises assigning a digital information identifier to each data packet.

17. The method of claim 13, wherein the step of breaking up the digital information comprises assigning a sequence number to each data packet.

18. The method of claim 13, wherein the digital information comprises a data file.

19. A radio frequency (RF) data storage device, comprising:
an RF transponder, the transponder comprising an internal memory and an external memory interface; and
a microcontroller that is in communication with the transponder via the external memory interface, the microcontroller comprising a non-volatile memory unit;
wherein the RF transponder receives data over an RF broadcast, temporarily stores the data in the internal memory, assigns an address to the data, and sends the data to the microcontroller via the external memory interface for storage in the non-volatile memory unit at the assigned address.

20. The device of claim 19, wherein the transponder, upon receiving a request for the data, sends the request to the microcontroller which in turn retrieves the requested data from the non-volatile memory unit and sends the requested data via the external memory interface to the RF transponder's internal memory where the requested data can be read by an RF interrogator.

21. The device of claim 19, wherein the transponder further comprises an RF transmitter for transmitting the requested data to a remote device.

22. The device of claim 19, wherein the non-volatile memory unit comprises flash memory.

23. The device of claim 19, wherein the internal memory comprises an EEPROM.

24. The device of claim 19, further comprising an external energy source that provides energy to the microcontroller.

25. The device of claim 24, wherein the RF transponder is in communication with the external energy source, the transponder synchronously sending a wakeup signal to the external energy source when it sends the data to the microcontroller.

26. A remote data sharing system, comprising:
a first sensor that is in communication with a microcontroller, the microcontroller comprising a non-volatile memory unit and an analog-to-digital converter; and
an RF transponder that is in communication with the microcontroller, the transponder comprising an internal memory;
wherein the first sensor takes a first measurement from a first location and sends the first measurement to the converter, which converts the first measurement into a first digital data value and stores the first digital data value in the memory unit; and
wherein the RF transponder retrieves the first value from the microcontroller's memory unit and stores the first value in the transponder's internal memory where the first value can be read by an RF interrogator.

27. The system of claim 26, wherein the first measurement comprises a temperature measurement.

28. The system of claim 26, further comprising a second sensor that is in communication with the microcontroller, wherein the second sensor takes a second measurement from a second location and sends the second measurement to the converter, which converts the second measurement into a second digital data value and stores the second digital data value in the memory unit.

29. The system of claim 28, wherein the RF transponder retrieves the second value from the microcontroller's memory unit and stores the second value in the transponder's internal memory where the second value can be read by an RF interrogator.

30. The system of claim 29, wherein the first and second measurements comprise temperature measurements.

31. The system of claim 29, wherein the first and second measurements comprise measurements of light, sound, weight, pressure, or speed.

32. The system of claim 30, wherein the microcontroller calculates a temperature gradient based on the first and second digital data values.

33. A radio frequency (RF) interrogation system for reading digital information from one or more RF transponders, comprising:
a microcontroller module, the microcontroller module comprising a microcontroller and a buffer memory space; and
a digital signal processing module providing direct control over operations of a radio module in response to commands provided by the microcontroller, the radio module providing RF communications with the transponders;
wherein the radio module receives one or more data packets over a RF modulated signal from the transponders and sends the data packets to the microcontroller module, which reconstructs the data packets into the digital information.

34. The system of claim 33, wherein the microcontroller module comprises DRAM that is accessible by the microcontroller and provides for volatile storage of data values generated during the execution of instructions by the microcontroller.

35. The system of claim 33, wherein the microcontroller module comprises flash memory that provides non-volatile memory storage for the microcontroller.

36. The system of claim 33, wherein the microcontroller module comprises an Ethernet interface for communicating with an a local area network.

37. The system of claim 33, wherein the radio module comprises a local oscillator that generates an RF carrier frequency.

38. The method of claim 33, wherein the digital information comprises a data file.

39. The method of claim 33, wherein the digital information comprises configuration information for an electronic device.

40. The method of claim 33, wherein at least one data packet comprises a digital information identifier.

41. The method of claim 33, wherein each data packet comprises a sequence number.

42. A radio frequency (RF) interrogation system for writing configuration information for an electronic device onto one or more RF transponders, comprising:
a microcontroller module, the microcontroller module comprising a microcontroller and a buffer memory space; and
a digital signal processing module providing direct control over operations of a radio module in response to commands provided by the microcontroller, the radio module providing RF communications with the one or more transponders;
wherein the microcontroller module retrieves the configuration information from the buffer memory space and breaks up the configuration information into multiple data packets;
wherein the digital signal processing module directs the radio module to broadcast the data packets over a RF modulated signal to the one or more transponders for writing thereon.

43. A method of writing configuration information for an electronic device onto one or more radio frequency (RF) transponders, comprising the steps of:
determining the amount of data in the configuration information;
calculating the number of transponders required to hold the determined amount of data;
verifying that there are a sufficient number of transponders to hold the data in the data file; and
broadcasting the configuration information over a RF modulated signal to the one or more transponders for writing thereon.
